(19) United States
(12) Patent Application Publication
(10) Pub. No.: US 2015/0123776 A1
(43) Pub. Date: May 7, 2015

(54) HAPTIC INTERFACE HAVING SEPARATED INPUT AND OUTPUT POINTS FOR VARIED AND ELABORATE INFORMATION TRANSFER

(71) Applicant: KOREA ADVANCED INSTITUTE OF SCIENCE AND TECHNOLOGY, Daejeon (KR)

(72) Inventors: Doo Yong Lee, Seoul (KR); Yun Jin Gu, Daejeon (KR); Hoe Ryong Jung, Daejeon (KR); Boo Won Kang, Daejeon (KR); Myeon Gin Kim, Deajeon (KR); Hyuk Wang, Daejeon (KR); Seong Pil Byeon, Daejeon (KR); Seung Gyu Kang, Daejeon (KR)

(73) Assignee: KOREA ADVANCED INSTITUTE OF SCIENCE AND TECHNOLOGY, Daejeon (KR)

(21) Appl. No.: 14/381,448

(22) PCT Filed: Jan. 7, 2013
(86) PCT No.: PCT/KR2013/000099

§ 371 Date: Aug. 27, 2014

(30) Foreign Application Priority Data
Feb. 28, 2012 (KR) 10-2012-0020153

(51) Int. Cl. G06F 3/01

(52) U.S. Cl. CPC G06F 3/016
USPC 340/407.2

(57) ABSTRACT

Provided is a haptic interface for allowing various information exchange in addition to transmitting accurate force information to an operator, and more particularly, a haptic device capable of transmitting more various kinds of information by transmitting necessary information to an operator by means of different kinds of sensations such as sight sensation, acoustic sensation, smell sensation, taste sensation or the like in addition to tactile sensation.

In addition, provided is a haptic device, which may have an input point and an output point in accordance with each other or in discordance from each other, may have various output points to give a feedback to various points desired by an operator, may give a feedback by adjusting intensity of an output instead of outputting simple on/off signals when providing information to an operator by means of a feedback, and allows a feedback output intensity to be calculated in various ways according to an input amount and fed back to the operator when the input amount input through a haptic interface by the operator is adjustable.

### TECHNICAL FIELD

The present disclosure relates to a haptic device, and more particularly, to a haptic interface for allowing various information exchanges in addition to transmitting accurate force information to an operator.

In particular, the present disclosure relates to a haptic device capable of transmitting more various kinds of information by transmitting necessary information to an operator by means of different kinds of sensations such as sight sensation, acoustic sensation, smell sensation, taste sensation or the like in addition to tactile sensation.

In addition, the present disclosure relates to a haptic device, which may have an input point and an output point in accordance with each other or in discordance from each other, may have various output points to give a feedback to various points desired by an operator, may give a feedback by adjusting intensity of an output instead of outputting simple on/off signals when providing information to an operator by means of a feedback, and allows a feedback output intensity to be calculated in various ways according to an input amount and fed back to the operator when the input amount input through a haptic interface by the operator is adjustable.

### BACKGROUND ART

Along with the development of techniques, various kinds of instruments and devices (hereinafter, generally referred to as “devices”) have been developed, and various kinds of interfaces are being used for transmitting information between such devices and human being. A keyboard, a mouse, a monitor, a speaker or the like of a computer are most universal interfaces.

The interface technique has depended on just sight and acoustic sensation. However, recently, along with the development of virtual reality systems, game devices and medical equipment, various kinds of interfaces are being rapidly developed so that a human may input a command to a control device such as a computer and directly feel an output control signal from the computer. Among such operator interfaces, a haptic interface has been developed to transmit even tactile sensation and force so as to provide concrete and realistic information to the operator.

The haptic interface is largely used in various fields such as virtual reality remote control, medical fields, education fields, entertainment fields or the like. The haptic interface is composed of hardware for reflecting tactile sensation and software for reproducing tactile sensation. The hardware is composed of a driving unit, sensors and instruments, and the software is haptic rendering for determining a force output in consideration of a virtual environment and a fed-back operator location and includes 3-dimensional graphic rendering software in a sight sensation display.

This haptic interface technique is used for a haptic device having two degrees of freedom having a manual degree of freedom (Patent Literature 1), a system and method for providing a force feedback to a user (Patent Literature 2), a haptic device for simulating digestive organ endoscope training (Patent Literature 3), a haptic feedback generating apparatus and method for complementing an initial reaction time and providing more diverse haptic feedbacks (Patent Literature 4), a driver, a haptic using the same, a robot device, and a system using the same (Patent Literature 5) or the like.

However, the haptic device used in the above techniques includes an input point and an output point at the same location. Therefore, a signal fed beck to an operator with respect to a control signal input by the operator is output to the output point while a control signal is being input, and thus feedback information may be transmitted to the operator simultaneously. However, since the feedback signal transmitted to the operator is output at the same location while the control signal is being input, when an impact is applied by the feedback signal, an error may occur in the input of the control signal. Moreover, only a single feedback signal is transmitted, and various kinds of feedback information may not be transmitted to the operator.

In other words, some devices such as medical instruments controlled using the haptic device should feed various feedback signals to the operator. In this case, various kinds of feedback information may exist with respect to the control signal input at the input point, but the existing haptic device is just capable of transmitting only a single feedback signal to an operator but is not capable of various kinds of information to the operator. In addition, since the input point and the output point are identical, the feedback output is transmitted to the operator simultaneously with the input of a signal, which may give confusion to the operator or cause an error to the input of the control signal due to an influence of the feedback signal.

### RELATED LITERATURES

### Patent Literature

(Patent Literature 1) 1. Korean Patent Registration No. 0463757

(Patent Literature 2) 2. Korean Patent Registration No. 1009865

(Patent Literature 3) 3. Korean Patent Registration No. 0934266

(Patent Literature 4) 4. Korean Patent Registration No. 1097852

(Patent Literature 5) 5. Korean Patent Publication No. 2010-0107231

### DISCLOSURE

### Technical Problem

The present disclosure is directed to providing a haptic device, which may feed various kinds of information back to an operator.

In particular, the present disclosure is directed to providing a haptic device, which may transmit more various kinds of information by transmitting necessary information to an operator by means of different kinds of sensations such as sight sensation, acoustic sensation, smell sensation, taste sensation or the like in addition to tactile sensation.

Further, the present disclosure is directed to providing a haptic device, which may have various output points to give a feedback to various points desired by an operator, may give a feedback by adjusting intensity of an output instead of outputting simple on/off signals when providing information to an operator by means of a feedback, and allows a feedback output intensity to be calculated in various ways according to an input amount and fed back to the operator when the input amount input through a haptic interface by the operator is adjustable.

### Advantageous Effects

In the present disclosure, various kinds of information with different intensities according to a state of an instrument (a location, a moving distance, a distance from a target 6, temperature transferred from the target, an image sensed from the target, or the like) may be provided to an operator so that the instrument may be controlled more stably.

Further, in the present disclosure, information necessary for an operation may be transferred by means of various kinds of natural sensation such as sight sensation, acoustic sensation, smell sensation, taste sensation or the like as well as tactile sensation so that a precise instrument such as a medical instrument may be controlled more accurately.

In other words, since a feedback output is transmitted to an operator in proportion to each state, rather than an on/off signal, the instrument may be operated according to a contact between a target (for example, an operation spot in a surgical operation, or a location of an endoscope or a contact between the endoscope and the stomach wall) or a state of the target. In addition, if the operator may adjust an input amount to an input unit of the haptic device, the feedback output intensity may be calculated in various ways according to the input amount and may be fed back to the operator, which allows precise control of the instrument.

### DESCRIPTION OF DRAWINGS

FIG. 1 is a diagram showing a haptic device according to the present disclosure,

FIG. 2 shows a proximity distance recognizing system at a mobile platform, which is an example of the haptic device according to the present disclosure,

FIG. 3 shows a bending information feedback output unit of an endoscope and catheter, which is another example of the haptic device according to the present disclosure,

FIG. 4 shows an image output unit for preventing perforation during an endoscopy procedure and also preventing a patient from feeling a pain, which is another example of the haptic device according to the present disclosure, and

FIG. 5 is a perspective view showing an example of an input unit and an output unit, separated from each other, in the haptic device according to the present disclosure.

### BEST MODE

Hereinafter, exemplary embodiments which can be easily implemented by those skilled in the art will be described with reference to the accompanying drawings. In each drawing of the present disclosure, sizes or scales of components may be enlarged or reduced than their actual sizes or scales for better illustration, and known components are not depicted therein to clearly show features of the present disclosure. Therefore, the present disclosure is not limited to the drawings. When describing the principle of the embodiments of the present disclosure in detail, details of well-known functions and features may be omitted to avoid unnecessarily obscuring the presented embodiments.

The term ‘asymmetry’ used in the present disclosure has various meanings. First, this term means that an input command input by a human does not match with an output command of a haptic device in a one-to-one relation. In other words, the input may be not only a force vector command but also a scalar input signal such as a simple on/off electric signal, or their combinations. When receiving a feedback from a haptic device, tactile sensation feedback and five sense feedback may be received in addition to force feedback, which allows a user to recognize information in various ways. Second, this term means that an input point and an output point are not identical. For example, a muscle sense input by an operation of the hand may be transmitted through a skin.

A haptic master device having multiple degrees of freedom may be generally classified into a portion for implementing and recognizing force feedback such as weight, shape, hardness or the like, obtained through a muscle sense path, and a portion for implementing and recognizing tactile sensation such as surface, pattern, warmth, pressure or the like, obtained through a skin sense path. The force feedback is implemented and recognized by means of a reflecting force by using an actuator, and its connection is made using an energy transfer device such as a wire.

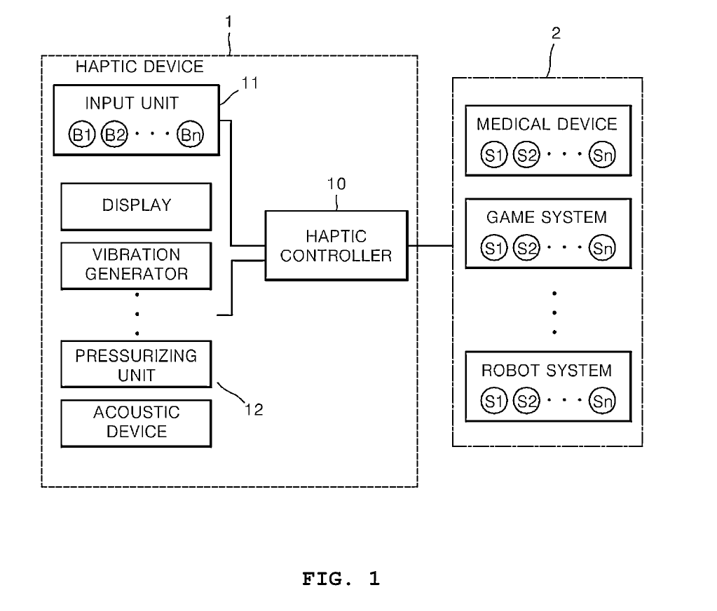

The present disclosure is directed to transmitting a feedback signal to an operator corresponding to an input value received from an instrument or in proportion to a response of the instrument or a response of a target sensed by the instrument, and also providing more diverse kinds of information by transmitting necessary information to the operator by means of various kinds of senses such as sight sensation, acoustic sensation, smell sensation, and taste sensation as well as tactile sensation. A haptic device 1 of the present disclosure includes various kinds of sensors S1 to Sn according to the kind of an instrument 2, and an output unit 12 for transmitting a feedback output in proportion to a driving state of the instrument to the operator as shown in FIG. 1.

In order to control the instrument 2, the output unit 12 transmits a feedback signal to the operator in proportion to the value input at the input unit 11, in proportion to the load applied to the instrument while the instrument is in operation, or in proportion to various kinds of information sensed from a target operated by the instrument. In other words, if the sensed information is strong, the feedback signal transmitted to the operator through the output unit 12 becomes strong, and if the sensed information is weak, the feedback signal also becomes weak.

The signal which becomes a cause of a signal fed back to the output unit may correspond to a state of the instrument, a load applied to the instrument or a state of the target, as described above, but it is desirable that the feedback signal may be transmitted in proportion to the state of the target.

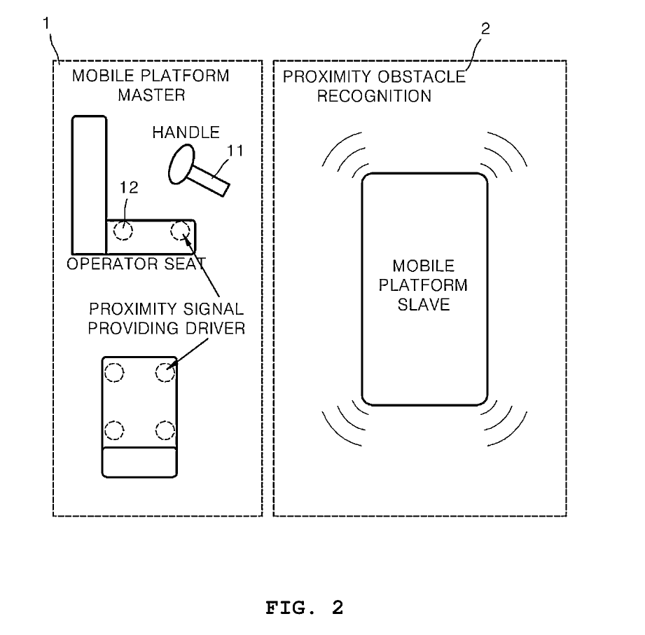

In other words, if the haptic device of the present disclosure is applied to a mobile platform operating system using remote control as shown in FIG. 2, the instrument 2 (a mobile platform slave) moves by operating various operation units such as a handle of the haptic device 1 (a master device), and as the instrument 2 serving as a mobile platform slave moves, a proximity obstacle sensor mounted to the slave recognizes an approaching obstacle. If an approaching obstacle is recognized, the output unit 12 (a proximity signal providing driver) disposed at an operator seat of the haptic device 1 (a mobile platform master) operates to provide various kinds of tactile sensation such as vibration to the operator to inform that a proximity obstacle is present. As the proximity obstacle moves closer to the instrument 2 (a slave), the output unit 12 serving as a proximity signal providing driver operates strongly to give a stronger signal to the operator so that the operator may recognize that the slave is close to the proximity obstacle by means of the intensity of signal.

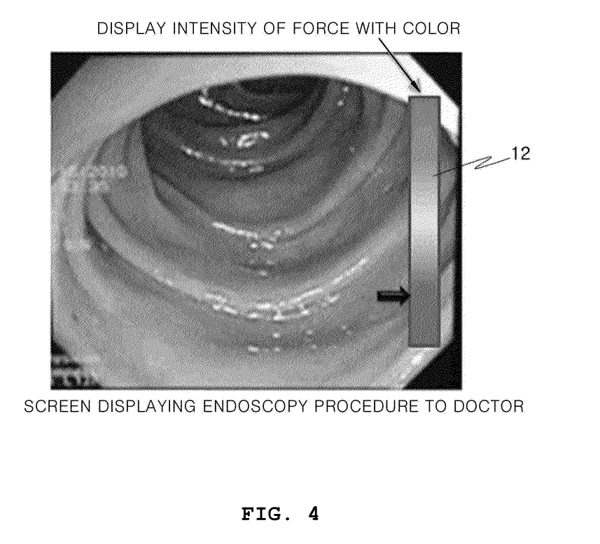

In addition, the feedback signal output to the output unit 12 may be fed back to the operator as various kinds of stimulation according to the signal sensed from an instrument or a target operated by the instrument, instead of simple tactile sensation information. In other words, the output unit 12 may transmit necessary information to the operator by means of various kinds of senses such as sight sensation, acoustic sensation, smell sensation, taste sensation or the like as well as tactile sensation. For example, a contact pressure generated when the instrument 2 comes into contact with a target is transmitted to the operator as a pressure which stimulates the tactile sensation, a location of an endoscope or a state of the endoscope and a stomach wall are provided as an image using sight sensation when the endoscope is used (see FIG. 4), and bad small information generated by decay may be provided by means of smell sensation.

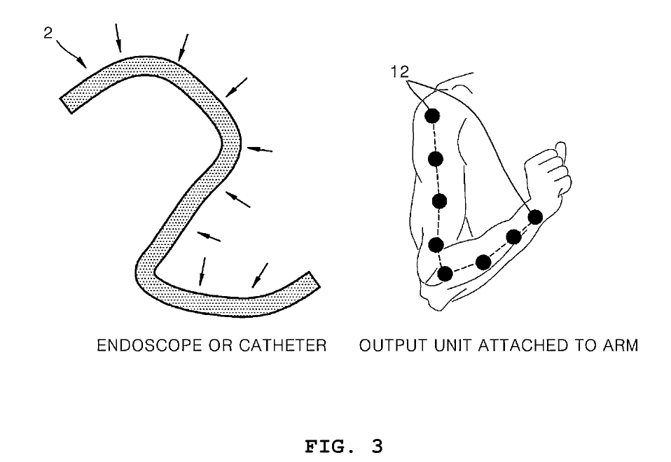

The output unit 12 and the input unit 11 may be installed at the same location as in an existing haptic device. However, if the output unit 12 and the input unit 11 are installed at the same location as above, while an operation signal (or, a control signal, hereinafter, generally referred to as a “control signal”) is being input at the input unit 11, a feedback signal is transmitted to the output unit 12, which may make the operator confused. Therefore, the output unit 12 and the input unit 11 may be provided at different locations. In particular, in case of a signal fed back by a stimulation such as sight sensation and smell sensation, the output unit may not be installed at the same location as the input unit 11 operated by the hand, and as shown in FIG. 3, in case of a tactile sensation signal, the input unit 11 and the output unit 12 may not be installed at the same location if bending information of an endoscope or a catheter is transmitted corresponding to bending of an arm.

In other words, in the haptic device of the present disclosure, the input unit 11 and the output unit 12 may be installed separately so that the input unit 11 inputs only a control signal and the output unit 12 transmits only a feedback signal to the operator.

As described above, the haptic device of the present disclosure may provide a feedback signal to an operator as various kinds of stimulation, and accordingly the output unit 12 may be made in various forms. Here, a desirable example of the output unit 12 is a display such as a monitor, and the feedback signal may be displayed graph whose color or chroma changes according to a size of the feedback signal (see FIG. 4). As another example, the output unit 12 may employ a vibration generator, whose vibration may also increase in proportion to a size of the feedback signal (see FIG. 2). As another example of the output unit 12, a pressurizing unit installed to a body of the operator to press the body to give a pressure to the body may also be used (see FIG. 3).

As described above, the output unit 12 may employ any one already developed, and this is not described in detail here.

In addition, it is possible that a plurality of output units 12 is installed. In other words, the instrument 2 may operate in various ways, and during this operation, the sensors may have the same kind but sense different kinds of stimulations or different simulation intensities. Accordingly, the plurality of output units 12 may be installed so that simulations sensed by various sensors are entirely or selectively transmitted to the output units 12.

The output unit 12 may be integrally configured with the haptic device 1, or as shown in FIG. 3, the output unit 12 may be detachably attached to a part of the body of the operator. In other words, if a feedback signal is provided by means of tactile sensation as shown in FIG. 3, the output unit 12 may employ a pressurizing unit which may be attached to and detached from a part of the body of the operator. In addition, if a feedback signal is provided by means of smell sensation, the output unit 12 is attached to or detached from the nose, and if a feedback signal is provided by means of acoustic sensation, the output unit 12 may be attached to or detached from the ear.

A method for providing a feedback signal by using the haptic device of the present disclosure configured as above has already been described above but will be explained again below.

This method includes sensing a state of the instrument detected by a plurality of sensors S1 to Sn installed at the instrument; and transmitting, by the haptic controller 10 receiving the sensed state of the instrument, the feedback signal according to the state of the instrument to the output unit 12 so that the output is adjusted in proportion to the state of the instrument.

While the feedback signal is provided, the feedback signal may be output to the output unit 12 installed at the same location as the input unit 11. However, more desirably, the feedback signal is output to an output unit 12 provided at a location separated from the input unit 11. In other words, the input unit 11 inputs only a control signal, and the output unit 12 transmits only a feedback signal to the operator.

In addition, since a plurality of output units 12 is provided, it is possible to transmit the number of feedback signals corresponding to the number of signals sensed by the sensors to the output units, or it is also possible to select a part of feedback signals and transmits the feedback signals to the number of output units corresponding to the number of selected feedback signals. The feedback signal may be provided through the output unit to the operator as various kinds of information such as smell sensation, acoustic sensation, sight sensation or the like as well as tactile sensation.

As described above, the haptic device of the present disclosure may be implemented in various forms in various fields as described above, and their examples will be described below.

### EXAMPLE 1

### Mobile Platform Operating System Using Remote Control

FIG. 2 is a diagram showing that a mobile platform operating system performs proximity distance recognition.

As shown in FIG. 2, the instrument 2 serving as a mobile platform slave moves by an operation of various operating devices such as a handle of the haptic device 1 serving as a master device, and as the mobile platform slave (the instrument) is moving, a proximity obstacle recognition sensor mounted to the slave recognizes a proximity obstacle. If the proximity obstacle is recognized, a proximity signal providing driver (the output unit) mounted to an operator seat of the mobile platform master (the haptic device) operates to provide various kinds of tactile sensations to the operator to inform that the proximity obstacle is present. As the proximity obstacle moves closer to the slave (the instrument), the proximity signal providing driver (the output unit) operates strongly to give a stronger signal to the operator so that the operator may recognize that the slave is close to the proximity obstacle by means of the intensity of signal.

### EXAMPLE 2

### Bending Information Feedback System of an Endoscope and a Catheter

FIG. 3 is a diagram for illustrating a method or transmitting a feedback signal according to bending information of an endoscope or a catheter, as an example of the haptic device according to the present disclosure, which is applied to a medical instrument.

This is a system for transmitting bending information of a long tubular article (the instrument) such as an endoscope or a catheter to the operator, and as shown in FIG. 3, a device (the output unit) for providing a bending feedback to the arm of the operator is mounted. The feedback transmitted to the output unit may be provided as a simple vibration or a bending force vector which represents an actual bending direction of the endoscope or catheter.

### EXAMPLE 3

### Reaction Display graphical User Interface (GUI) for Preventing Perforation During an Endoscopy and Preventing a Patent from Feeling a Pain

FIG. 4 shows a system for sensing a force obtained when an endoscope collides with an organ of a patient during endoscopy and displaying the degree of force on a screen by means of sight sensation. This system senses a force generated by a collision between the endoscope and another article by using a sensor which measures a collision with the endoscope (the instrument), and intuitively displays the degree of sensed force on a screen (the output unit) through the endoscope, thereby preventing any medical accident caused by excessive manipulation of the endoscope (the instrument). The pressure generated by the contact between the endoscope (the instrument) and an organ may be displayed as shown in FIG. 3 or may also be fed back to the output unit, which outputs tactile sensation (pressure, vibration) as shown in FIG. 2.

### EXAMPLE 4

### Impact and Acceleration Sensation Transmitting Device in a 3-Dimensional Game

Though not shown in the figures, the haptic device of the present disclosure may be applied to a game system as another example.

General input devices used in a game include a keyboard, a mouse, a game pad or the like, which however just play a role of an input unit and are not capable of giving a realistic feeling about situations in the game. Therefore, the haptic device of the present disclosure may give more realistic feeling in association with a game system. In this game system, the output unit may be attached to the shoulder and the arm to give additional sensations of impacts and accelerations, which are felt in a 3-dimensional space.

For example, in a first-person shooting game which executes in a 3-dimensional space, an attack direction of an opponent may be fed back to the body of an operation as a pressure or vibration, which may enhance the sense of reality and provide additional information required for the game to the user.

In case of a car racing game, an acceleration generated when a car is inclined to a side or runs on a curved lane may be provided through an output unit attached to the body of an operator (a gamer) to give acceleration information in the game as if the user feels it during an actual drive.

In other words, after a plurality of output units is attached to the body of an operator, a feedback signal may be transmitted to an output unit at a corresponding location to transmit an impact portion, impact intensity, an inclination angle, a speed or the like to the operator.

### EXAMPLE 5

### Low Inertia Haptic Device having many Degrees of Freedom

A haptic device having many degrees of freedom includes many drivers to provide feedbacks to every degree of freedom, which increases the inertia moment. Therefore, the degree of freedom for an input and the degree of freedom for a feedback output may be partially divided so that many degrees of freedom may be implemented with small inertia moment.

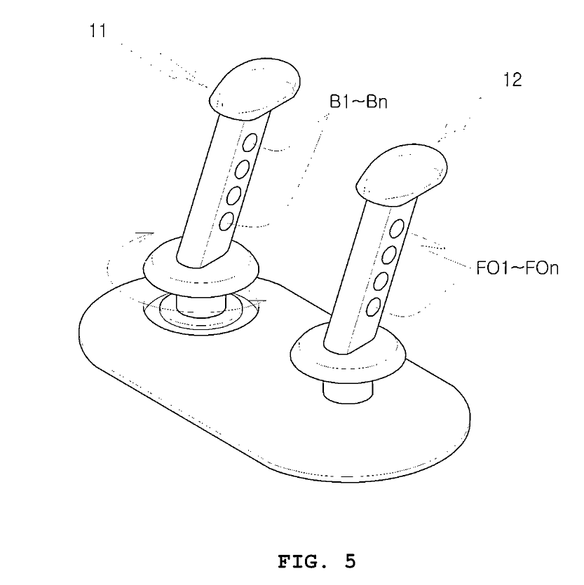

In other words, as shown in FIG. 5, the input unit 11 of the haptic device plays just a role of inputting a control signal (an operation) of the operator and may individually control each driving unit of an instrument having many driving units. The output unit 12 is used for providing only a feedback signal to the operator and has a plurality of output units so that the instrument responding to the control signal input through the input unit may provide feedback signals according to operation of the driving units to the operator entirely or selectively.

For example, in case of the needle insertion operation, when a needle is inserted, linear movement (one degree of freedom), force of the needle (two degrees of freedom), drug injection (multiple degrees of freedom according to the kind of drug) or the like should be sensed and notified to an operator. In the present disclosure, a plurality of input units and output units are provided as described above. Therefore, an operating speed of the operator and a force vector command may be input through a single input unit, and various kinds of resultant output feedbacks may be provided to the operator.

### REFERENCE SYMBOLS

1: haptic device
10: haptic controller
11: input unit
12: output unit
2: instrument

What is claimed is:

1. A medical haptic interface of a medical haptic apparatus for medical procedures or training, comprising:
an input unit for inputting a control signal to a mechanism through a multi-degree of freedom operating device; and
a feedback output unit for transferring an output signal, fed back from the mechanism, to an operator,
wherein the input and the feedback output of the medical haptic apparatus are asymmetric, and
wherein the feedback output unit is installed at a point of a body of the operator, which is different from a point of the input unit, and is output to the operator with a sense different from an input sense at a point different from an operating point.

2. The medical haptic interface according to claim 1,
wherein the input unit is a tubular endoscope or catheter, and the feedback output unit is attached to an arm of the operator.

3. The medical haptic interface according to claim 1,
wherein the feedback output unit is attached to an ear in case the feedback output is an auditory sense, and the feedback output unit is attached to a nose in case the feedback output is an olfactory sense.

4. The medical haptic interface according to claim 1,
wherein the feedback output unit is installed at or near a seat which comes into contact with the body of the operator, at a point different from the point of the input unit.

5. The medical haptic interface according to claim 4,
wherein the feedback output unit is a display which visually expresses a force vector reaction of a medical instrument with a color or chroma signal.

6. The medical haptic interface according to claim 1,
wherein the feedback output unit expresses an output with a skin sense in case the input is a force vector by installing a pressing unit at a shoulder or arm.
